(19) United States
(12) Patent Application Publication
(10) Pub. No.: US 2025/0269709 A1
(43) Pub. Date: Aug. 28, 2025

(54) ARTICULATED RIGID AXLE OF A VEHICLE WITH AN AXLE SUPPORT WITH AN ELECTRIC MACHINE AS DRIVE

(71) Applicant: ZF Friedrichshafen AG, Friedrichshafen (DE)

(72) Inventor: Thomas Waim, Grafenau (DE)

(73) Assignee: ZF Friedrichshafen AG, Friedrichshafen (DE)

(21) Appl. No.: 19/054,089

(22) Filed: Feb. 14, 2025

(30) Foreign Application Priority Data
Feb. 22, 2024 (DE) 10 2024 201 610.1

(51) Int. Cl. B60K 1/00

(52) U.S. Cl. CPC B60K 1/00; B60K 2001/001

(57) ABSTRACT

An articulated rigid axle of a vehicle (1) with an axle bridge (2) has at least one electric machine as drive, where the at least one electric machine is connected via at least one gear ratio step to at least one drive output shaft (3, 4). A steered vehicle wheel (7, 8) is mounted to rotate is connected to each drive output shaft (3, 4). The gear ratio step is in the form of a bevel gear transmission stage (9, 10) for compensating an axis offset between a wheel axis (11) of the vehicle wheels (7, 8) and a drive axle (12) of the electric machine. In addition, a vehicle (1) with at least one rigid axle is proposed.

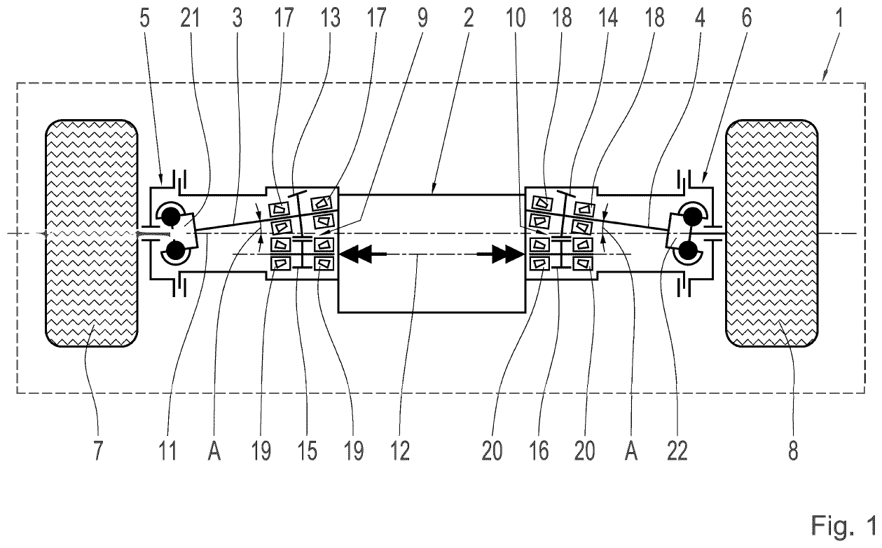

### RELATED APPLICATIONS

This application claims the benefit of and right of priority under 35 U.S.C. § 119 to German Patent Application no. 10 2024 201 610.1, filed on 22 Feb. 2024, the contents of which are incorporated herein by reference in its entirety.

### FIELD OF THE DISCLOSURE

The present invention relates to an articulated rigid axle of a vehicle having an axle bridge with at least one electric machine as drive. In addition, the invention relates to a vehicle with at least one articulated rigid axle.

### BACKGROUND

From automotive technology, articulated rigid axles having an axle bridge with steerable vehicle wheels connected thereto are well enough known. The known rigid axles are usually driven mechanically by way of a cardan shaft or the like, and the drive output takes place via a differential gear system. The differential gear system ensures a uniform distribution of the torque to the vehicle wheels.

When an electric machine is used as the drive in the axle bridge of the articulated rigid axle as an electric drive, the problem arises that at least one transmission ratio stage is needed between the electric machine and the drive output shafts, in order to increase the drive torque to a required level. This produces a corresponding axial offset between a wheel axle of the vehicle wheels and a drive axle of the electric machine, so that the fitting space required in the axle bridge of the rigid axle is increased to a disadvantageous extent.

### SUMMARY

The purpose of the present invention is to propose an articulated electrically driven rigid axle and a vehicle with the rigid axle, which provide a sufficient gear ratio in a manner that saves fitting space and that is efficient.

According to the invention that objective is achieved by an articulated rigid axle of a vehicle having an axle bridge with at least one electric machine, and by a vehicle having such an articulated rigid axle. Advantageous further developments emerge from the claims, the description, and the drawing

Thus, an articulated rigid axle of a vehicle with an axle bridge having at least one electric machine as drive is proposed, which drive is connected by way of at least one gear ratio step to at least one drive output shaft, wherein a steerable vehicle wheel mounted on the axle bridge is connected to each drive output shaft and the said gear ratio step is in the form of a bevel gear transmission stage for compensating an axis offset between a wheel axis of the vehicle wheels and a drive axle of the electric machine.

In this way, with the electrically driven rigid axle having the drive output shafts arranged at a predetermined oblique angle, by virtue of the bevel gear transmission stage provided on each drive output shaft as an angle gear, on the one hand a sufficient final gear ratio is produced and on the other hand the additional axis separation due to the oblique arrangement of the drive output shafts is compensated, so that the bevel gear transmission stages with their associated drive output shafts can be integrated into the existing fitting space in the axle bridge. Thus, not only is a sufficient gear ratio achieved in a space-saving manner, but also, owing to the outer teeth stage, a robust bearing arrangement in the proposed rigid axle is made possible.

In the context of the invention, with the rigid axle claimed it is possible to use various types of angle gears. It is particularly preferable, in the bevel gear transmission stage, to provide gearwheels with straight, oblique or curved teeth. Consequently, in the bevel gear transmission stage gearwheels for example with beveloid, crown, spiral bevel, zerol bevel or hypoid gearteeth or the like can be used.

To produce an axis angle between the drive output shafts, in the context of the invention it is possible for at least one gearwheel of the bevel gear transmission stage to be in the form of a bevel gear. For example, two bevel gears or tapered gearwheels or the like that mesh with one another can be used in the bevel gear transmission stage in order to compensate the axis offset between the wheel axis and the drive axle of the electric machine produced by the gear ratio step.

It is also conceivable that to produce the axis angle between the drive output shafts in order to compensate the axis offset between the wheel axis and the drive axle of the electric machine, in the context of the present invention, it can be provided that the bevel gear transmission stages comprise a bevel gear and a spur gear that meshes with the bevel gear.

To produce a stable bearing arrangement in the bevel gear transmission stage, if two bevel gears are used it can be provided that each bevel gear of the bevel gear transmission stage is mounted by means of roller bearings on both sides on the associated drive output shaft or on a rotation axis arranged coaxially with the drive axle.

When a bevel gear and a spur gear are used, it can be provided that the spur gear of the bevel gear transmission stage is mounted by means of roller bearings on both sides on a rotation axis arranged coaxially with the drive axle or on the associated drive output shaft.

As roller bearings, needle, ball, or bevel roller bearings or the like can be used. In this case it is possible to use O-bearing arrangements, X-bearing arrangements and floating-fixed bearing arrangements as well as other commonly used bearing systems.

To compensate the axis angle of the obliquely arranged drive output shafts, a constant-velocity joint or the like is provided on the end of each drive output shaft that faces toward the vehicle wheel.

If the articulated rigid axle is designed with separately driven drive output shafts without a differential gear system, then in the context of the invention it can be provided that for such separate driving each drive output shaft is coupled to an electric machine via at least one bevel gear transmission stage as its gear ratio.

It is also conceivable that with a design of the articulated rigid axle having a common drive of the drive output shafts via a differential gear system, in the context of the invention, it can be provided that the two drive output shafts are each coupled by way of at least one bevel gear transmission stage to a differential gear system for driving in common by means of an electric machine.

The stated objective of the invention is also achieved by a vehicle with at least one articulated rigid axle as described above, by virtue of which the already described and further advantages are obtained.

### BRIEF DESCRIPTION OF THE DRAWING

Below, the present invention is explained in greater detail with reference to the sole FIGURE.

### DETAILED DESCRIPTION

The sole FIGURE of the invention shows a schematically represented embodiment variant of an articulated rigid axle according to the invention on a vehicle 1 shown only as an example.

The articulated rigid axle comprises an axle bridge 2, depending on the design, with at least one electric machine (not illustrated further), which for example is connected directly or via a gear ratio step (also not illustrated further) to a differential gear system (again, not illustrated further) as the drive input in common to a first drive output shaft 3 and a second drive output shaft 4. However, it is also conceivable that an electric machine is associated with each of the drive output shafts 3, 4, and in that case the drive output shafts 3, 4 are each coupled via at least one gear ratio to the respective electric machine associated with it. In the figure the arrangement of the at least one electric machine and, if present, the differential gear system as well as the possible gear ratio steps is just indicated by a box.

On each drive output shaft 3, 4 a steerable vehicle wheel 7, 8 is connected by an associated steering knuckle 5, 6, which wheel is driven via the associated drive output shaft 3, 4 by the electric machine or electric machines.

To produce a sufficient final gear ratio, on each drive output shaft 3, 4 a bevel gear transmission stage 9, 10 in each case is realized as a gear ratio step to compensate the axis offset produced between a wheel axis 11 and a drive axle 12 of the electric machine.

In the embodiment variant shown as an example, each bevel gear transmission stage 9, 10 comprises a bevel gear 13, 14 which meshes with a spur gear 15, 16. Each bevel gear 13, 14 of the bevel gear transmission stage 9, 10 is mounted on its associated drive output shaft 3, 4 by means of two bevel roller bearings 17, 18, preferably in an O-configuration, whereas each spur gear 15, 16 is mounted on a rotation axis coaxial with the drive axle 12 by means of two bevel roller bearings 19, 20, preferably in an O-configuration.

Each drive output shaft 3, 4 is arranged in the axle bridge 2 at a predetermined axis angle A relative to the wheel axle 11. The axis angle A is compensated at the drive-side end of the respective drive output shaft 3, 4 by the associated bevel gear transmission stage 9, 10. To compensate the axis angle A at the end of each drive output shaft 3, 4 directed toward the vehicle wheel 7, 8, a constant-velocity joint 21, 22 is provided in each case.

### INDEXES

1 Vehicle
2 Axle bridge
3 Drive output shaft
4 Drive output shaft
Steering knuckle
6 Steering knuckle
7 Vehicle wheel
8 Vehicle wheel
9 Bevel gear transmission stage
10 Bevel gear transmission stage
11 Wheel axis of the vehicle wheels
12 Drive axle of the electric machine
13 Bevel gear
14 Bevel gear
15 Spur gear
16 Spur gear
17 Bevel roller bearing
18 Bevel roller bearing
19 Bevel roller bearing
20 Bevel roller bearing
21 Constant-velocity joint
22 Constant-velocity joint
A Axis angle

1. An articulated rigid axle of a vehicle (1), comprising:
an axle bridge (2) with at least one electric machine as drive;
at least one drive output shaft (3, 4) connected by way of at least one gear ratio step to at the axle bridge (2);
a steerable vehicle wheel is mounted on the axle bridge of each drive output shaft (3, 4); and
a gear ratio step in the form of a bevel gear transmission stage (9, 10) is configured to compensate an axis offset between a wheel axis 11 of each steerable vehicle wheel (7, 8) and a drive axle (12) of the at least one electric machine.

2. The articulated rigid axle according to claim 1, comprising: gearwheels with straight, oblique, and/or curved teeth in the bevel gear transmission stage (9, 10)

3. The articulated rigid axle according to claim 1, wherein at least one gearwheel of the bevel gear transmission stages (9, 10) is in the form of a bevel gear.

4. The articulated rigid axle according to claim 1, wherein the bevel gear transmission stage (9, 10) comprises a bevel gear (13, 14) and a spur gear (15, 16) that meshes with the bevel gear (13, 14).

5. The articulated rigid axle according to claim 3, wherein each gearwheel of the bevel gear transmission stages (9, 10) is mounted on a respectively associated drive output shaft (3, 4) or on a rotation axis arranged coaxially with the drive axle (12) by means of roller bearings on both sides.

6. The articulated rigid axle according to claim 1, wherein each drive output shaft (3, 4) is arranged in the axle bridge (2) at a predetermined axis angle (A) relative to the wheel axis (11).

7. The articulated rigid axle according to claim 6, wherein an end of each drive output shaft (3, 4) is directed toward the vehicle wheel (7, 8), and wherein the articulated rigid axle further comprises a constant-velocity joint (21, 22) configured to compensate the axis angle (A).

8. The articulated rigid axle according to claim 1, wherein each drive output shaft (3, 4) is coupled to an electric machine via at least one bevel gear transmission stage as a gear ratio, in order to be driven separately.

9. The articulated rigid axle according to claim 1, wherein the two drive output shafts (3, 4) are each coupled via at least one bevel gear transmission stage to a differential gear system to be driven in common by an electric machine.

10. A vehicle (1) having at least one articulated rigid axle according to claim 1.
